(19) United States
(12) Patent Application Publication
(10) Pub. No.: US 2022/0417837 A1
(43) Pub. Date: Dec. 29, 2022

(54) SELECTIVELY PROVIDING UNSOLICITED PROBE RESPONSES IN A BAND OF FREQUENCIES

(71) Applicant: ARRIS Enterprises LLC, Suwanee, GA (US)

(72) Inventor: Praveen K. Sirisilla, Fremont, CA (US)

(73) Assignee: ARRIS Enterprises LLC, Suwanee, GA (US)

(21) Appl. No.: 17/838,329

(22) Filed: Jun. 13, 2022

Related U.S. Application Data
(60) Provisional application No. 63/214,434, filed on Jun. 24, 2021.

(51) Int. Cl. H04W 48/16; H04L 5/00

(52) U.S. Cl. CPC H04W 48/16; H04L 5/0041; H04L 5/0053; H04L 5/001

(57) ABSTRACT

An access point that selectively provides an unsolicited broadcast probe response in a second band of frequencies (such as the 6 GHz band of frequencies) is described. During operation, the access point may receive information that indicates the electronic device is operating in a first band of frequencies (such as the 2.4 GHz and/or the 5 GHz bands of frequencies), and that the electronic device is within wireless-communication range of the access point. This information may include an identifier of the electronic device (such as a media access control address of the electronic device). Then, the access point may selectively provide, addressed to the electronic device, the unsolicited broadcast probe response in the second band of frequencies based at least in part on the information. Note that the unsolicited broadcast probe response may be provided during a time interval (such as the TBTT) and for a time duration.

### CROSS REFERENCE TO RELATED APPLICATIONS

This application claims priority under 35 U.S.C. 119(e) to U.S. Provisional Application Ser. No. 63/214,434, “Selectively Providing Unsolicited Probe Responses in a Band of Frequencies,” filed on Jun. 24, 2021, by Praveen K. Sirisilla, the contents of which are herein incorporated by reference.

### FIELD

The described embodiments relate to techniques for selectively providing unsolicited probe responses in a band of frequencies.

### BACKGROUND

Many electronic devices are capable of wirelessly communicating with other electronic devices. In particular, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Wash.), and/or another type of wireless network. For example, many electronic devices communicate with each other via wireless local area networks (WLANs) using an IEEE 802.11-compatible communication protocol (which is sometimes collectively referred to as ‘Wi-Fi’). In a typical deployment, a Wi-Fi-based WLAN includes one or more access points (or basic service sets or BSSs) that communicate wirelessly with each other and with other electronic devices using Wi-Fi, and that provide access to another network (such as the Internet) via IEEE 802.3 (which is sometimes referred to as ‘Ethernet’).

Recently, IEEE 802.11ax extended Wi-Fi to a 6 GHz band of frequencies, which is in addition to existing coverage in the 2.4 GHz and 5 GHz bands of frequencies. However, the use of the 6 GHz band of frequencies poses challenges for access-point discovery.

Notably, electronic devices can discover an access point operating in a particular band of frequencies by scanning available channels for beacons transmitted by the access point. Typically, an access point transmits a beacon in a given channel once within a target beacon transmit time (TBTT), e.g., every 100 ms. In the 2.4 GHz band of frequencies, there are 11 available channels and, in the 5 GHz band of frequencies, there are 20 available channels. Consequently, the scan time needed to discovery an access point operating in either of these bands of frequencies is reasonable, and an electronic device can discover and associate with an access point without excessive delay. However, because there are 55 available channels in the 6 GHz band of frequencies, the scan time needed to discovery an access point operating in this band of frequencies will be longer, which may result in an unacceptable delay for an electronic device to discover and associate with an access point.

In order to address this problem, in addition to transmitting a beacon every TBTT, in IEEE 802.11 ax an access point operating in the 6 GHz band of frequencies may optionally also send unsolicited broadcast probe responses at least every 20 transmitting units (TUs), e.g., 20.48 μs. This approach is more time effective for an electronic device that is performing a scan to discover an operating access point on a channel. Notably, for the 55 available channels, an electronic device performing a scan in 6 GHz band of frequencies can discover an access point in less than approximately 1 ms. However, an access point that transmits an unsolicited broadcast probe response every 20 TUs will consume medium time and, thus, will increase the overhead and reduce throughput. This additional overhead and reduced communication performance are unnecessary when an electronic device is not scanning the 6 GHz band of frequencies.

### SUMMARY

An access point that selectively provides one or more unsolicited broadcast probe responses in a second band of frequencies (such as the 6 GHz band of frequencies) is described. This access point may include an interface circuit that communicates with an electronic device. During operation, the access point may receive information that indicates the electronic device is operating in a first band of frequencies (such as the 2.4 GHz and/or the 5 GHz bands of frequencies) or is predicted to operate in the second band of frequencies, and that the electronic device is within wireless-communication range of the access point. This information may include an identifier of the electronic device (such as a media access control or MAC address of the electronic device). Then, the access point may selectively provide, addressed to the electronic device, the one or more unsolicited broadcast probe responses in the second band of frequencies based at least in part on the information.

Note that the access point may host multiple wireless local area networks (WLANs). For example, the access point may host a first virtual access point that provides a first WLAN that operates in the first band of frequencies and a second virtual access point that provides a second WLAN that operates in the second band of frequencies. Moreover, the information may be received by the second virtual access point from the first virtual access point.

Alternatively, the access point may receive the information from a second electronic device, such as another access point or a controller.

Furthermore, the information may indicate or specify that the electronic device is capable of operating in the second band of frequencies.

In some embodiments, the first virtual access point may: detect that the electronic device is operating in the first band of frequencies (e.g., the first virtual access point may receive a probe request associated with the electronic device); provide second information about the second virtual access point (e.g., a reduced neighbor report), such as in a beacon or a probe response addressed to the electronic device; and provide the information to the second virtual access point. Moreover, the first virtual access point may determine whether the electronic device is capable of operating in the second band of frequencies (e.g., based on an information element in the probe request that indicates that the electronic device is high-efficiency capable). Furthermore, the first virtual access point may optionally determine whether the electronic device is already known to the first virtual access point (e.g., by comparing the MAC address of the electronic device with stored MAC addresses in a look-up table). When the electronic device is already known to the first virtual access point, the first virtual access point may optionally not provide the information to the second virtual access point.

Note that the one or more unsolicited broadcast probe responses may be provided during a time interval (such as the TBTT) and for a time duration. For example, an unsolicited broadcast probe response may be provided every 20 TUs and/or the time duration may be between 5 and 10 s. Moreover, the unsolicited broadcast probe response may be provided starting at a predefined time (such as immediately or within 0.5 s).

In some embodiments, the access point may discontinue providing the unsolicited broadcast probe response in the second band of frequencies: when the electronic device is not operating in the first band of frequencies or is not predicted to operate in the second band of frequencies; when the electronic device is not within wireless-communication range of the access point; or when the time duration has expired.

Another embodiment provides the electronic device.

Another embodiment provides the second electronic device.

Another embodiment provides a computer-readable storage medium with program instructions for use with the access point. When executed by the access point, the program instructions cause the access point to perform at least some of the aforementioned operations in one or more of the preceding embodiments.

Another embodiment provides a method, which may be performed by the access point. This method includes at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for selectively providing an unsolicited broadcast probe responses in a second band of frequencies using an access point in FIG. 1 in accordance with an embodiment of the present disclosure.

FIG. 3 is a flow diagram illustrating an example of a method for providing information about an electronic device operating in a first band of frequencies or predicted to operate in a second band of frequencies using a computer in FIG. 1 in accordance with an embodiment of the present disclosure.

FIG. 4 is a drawing illustrating an example of communication among an electronic device and an access point in FIG. 1 in accordance with an embodiment of the present disclosure.

FIG. 5 is a drawing illustrating an example of messages in a band of frequencies in accordance with an embodiment of the present disclosure.

FIG. 6 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An access point that selectively provides an unsolicited broadcast probe response in a second band of frequencies (such as the 6 GHz band of frequencies) is described. During operation, the access point may receive information that indicates the electronic device is operating in a first band of frequencies or is predicted to operate in the second band of frequencies (such as the 2.4 GHz and/or the 5 GHz bands of frequencies), and that the electronic device is within wireless-communication range of the access point. This information may include an identifier of the electronic device (such as media access control or MAC address of the electronic device). Then, the access point may selectively provide, addressed to the electronic device, the unsolicited broadcast probe response in the second band of frequencies based at least in part on the information. Note that the unsolicited broadcast probe response may be provided during a time interval (such as the TBTT) and for a time duration. For example, the unsolicited broadcast probe response may be provided every 20 TUs and/or the time duration may be between 5 and 10 s. Moreover, the unsolicited broadcast probe response may be provided starting at a predefined time (such as immediately or within 0.5 s).

By selectively providing the unsolicited broadcast probe response, these communication techniques may provide improved communication performance. Notably, the communication techniques may allow the electronic device to discover the access point operating in the second band of frequencies with reduced scan time. Moreover, the communication techniques may reduce the overhead and may increase the throughput in the second band of frequencies by providing the unsolicited broadcast probe response when the electronic device is likely to perform a scan for the access point in the second band of frequencies. Consequently, the communication techniques may improve the user experience when communicating with the access point and/or in a network that includes the access point.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Tex.), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi, LTE and Ethernet are used as illustrative examples.

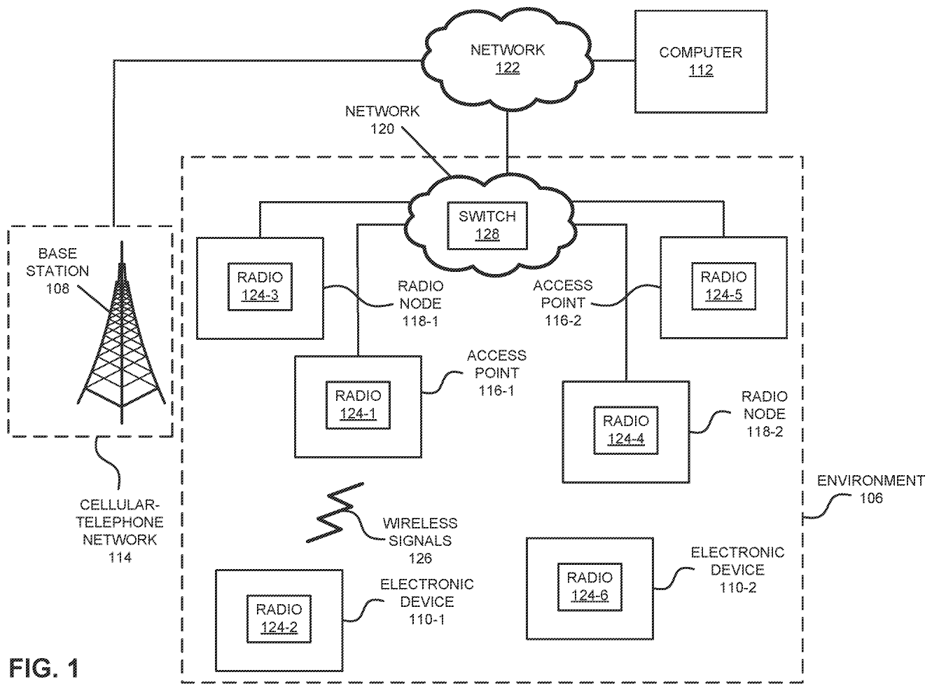

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or computer 112 (which may be a local or a cloud-based controller that manages and/or configures access points 116, radio nodes 118 and/or switch 128, or that provides cloud-based storage and/or analytical services) using a wired communication protocol (such as Ethernet) via network 120 and/or 122. Note that networks 120 and 122 may be the same or different networks. For example, networks 120 and/or 122 may an LAN, an intra-net or the Internet. In some embodiments, network 120 may include one or more routers and/or switches (such as switch 128).

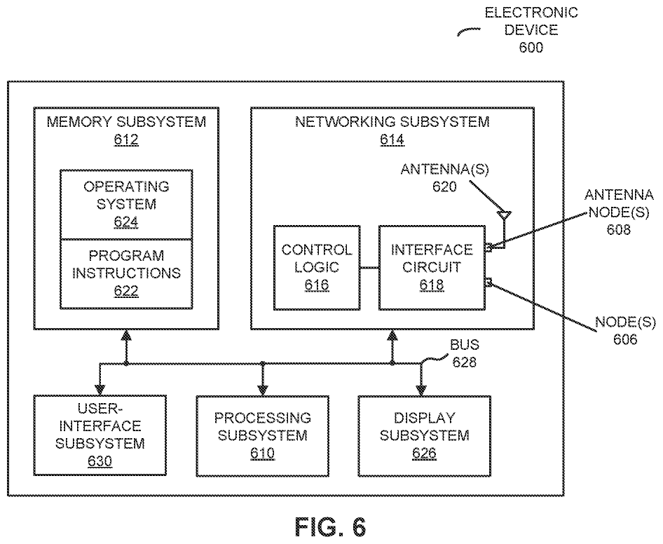

As described further below with reference to FIG. 6, electronic devices 110, computer 112, access points 116, radio nodes 118 and switch 128 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, in order to reduce scan times in the 6 GHz band of frequencies, access points may optionally send an unsolicited broadcast probe response at least every 20 transmitting units (TUs), e.g., 20.48 μs. However, access points that transmit an unsolicited broadcast probe response every 20 TUs will consume medium time and, thus, will increase the overhead and reduce throughput. This additional overhead and reduced communication performance are unnecessary when an electronic device is not scanning the 6 GHz band of frequencies.

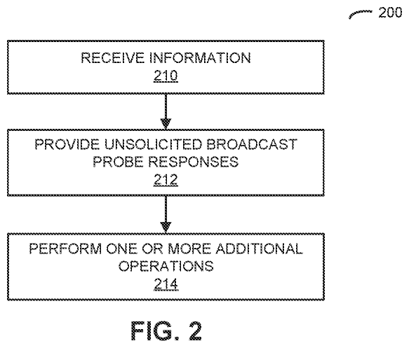

As described further below with reference to FIGS. 2-5, in order to address this problem an access point (such as access point 116-1) may selectively provide an unsolicited broadcast probe response (e.g., without first receiving one or more probe requests) in the 6 GHz band of frequencies. Notably, access point 116-1 may receive information that indicates an electronic device (such as electronic device 110-1) is operating in the 2.4 GHz and/or the 5 GHz bands of frequencies or is predicted to operate in the 6 GHz band of frequencies, and that electronic device 110-1 is within wireless-communication range of the access point. Note that the information may include an identifier of electronic device 110-1, such as a MAC address of electronic device 116-1. Then, access point 116-1 may selectively provide, addressed to electronic device 110-1, the unsolicited broadcast probe response in the 6 GHz band of frequencies based at least in part on the information. Note that an ‘unsolicited broadcast probe response’ may make electronic devices 110 receive and process the probe response, while a unicast probe response may cause other (non-addressed) electronic devices 110 to drop the frames.

In some embodiments, the unsolicited broadcast probe response may be provided during a time interval (such as the TBTT) and for a time duration. For example, the unsolicited broadcast probe response may be provided every 20 TUs and/or the time duration may be between 5 and 10 s. Note that the unsolicited broadcast probe response may be provided starting at a predefined time (such as immediately or within 0.5 s).

Moreover, access point 116-1 may discontinue providing the unsolicited broadcast probe response in the 6 GHz band of frequencies: when electronic device 110-1 is not operating in the 2.4 GHz and/or the 5 GHz bands of frequencies or is not predicted to operate in the 6 GHz band of frequencies; when electronic device 110-1 is not within wireless-communication range of access point 116-1; and/or when the time duration has expired.

In some embodiments, access point 116-1 may host a first virtual access point that provides a first WLAN that operates in the 2.4 GHz or the 5 GHz bands of frequencies and a second virtual access point that provides a second WLAN that operates in the 6 GHz band of frequencies. Moreover, the information may be received by the second virtual access point from the first virtual access point.

For example, the first virtual access point may: detect that electronic device 110-1 is operating in the 2.4 GHz and/or the 5 GHz bands of frequencies (e.g., the first virtual access point may receive a probe request from electronic device 110-1 in the 2.4 GHz and/or the 5 GHz bands of frequencies); determine whether electronic device 110-1 is capable of operating in the 6 GHz band of frequencies (e.g., based on an information element in the probe request that indicates that the electronic device is high-efficiency capable and, thus, is compatible with IEEE 802.11ax); and/or optionally determine whether electronic device 110-1 is already known to the first virtual access point (e.g., by comparing the MAC address of electronic device 110-1 with stored MAC addresses in a look-up table). Moreover, the first virtual access point may optionally: provide second information about the second virtual access point (e.g., a reduced neighbor report), such as in a beacon or a probe response addressed to electronic device 110-1; and provide the information to the second virtual access point. Alternatively, when electronic device 110-1 is already known to the first virtual access point, the first virtual access point may optionally not provide the second information to electronic device 110-1 and/or may not provide the information to the second virtual access point.

Furthermore, the information may indicate or specify that electronic device 110-1 is capable of operating in the 6 GHz band of frequencies. Note that access point 116-1 may only provide the unsolicited broadcast probe response when electronic device 110-1 is capable of operating in the 6 GHz band of frequencies.

While the 2.4 GHz and/or 5 GHz bands of frequencies, and the 6 GHz band of frequencies are used to illustrate the communication techniques, in other embodiments one or more different bands of frequencies may be used to detect or predict operation of electronic device 110-1 and/or to provide the unsolicited broadcast probe response.

Moreover, while access point 116-1 is illustrated as hosting multiple virtual access points, one of which provides the information, in other embodiments access point 116-1 receives the information from another access point (such as access point 116-2) and/or from a controller of access point 116-1 (such as computer 112).

In these ways, the communication techniques may allow access point 116-1 to reduce scan times in the 6 GHz band of frequencies, while reducing the overhead and improving the throughput (and, more generally, the communication performance). Consequently, the communication techniques may improve the user experience when communicating with access point 116-1 and, more generally, with a network that includes access point 116-1.

We now describe embodiments of the method. FIG. 2 presents a flow diagram illustrating an example of a method 200 for selectively providing an unsolicited broadcast probe response in a second band of frequencies (such as the 6 GHz band of frequencies), which may be performed by an access point (such as one of access points 116 and, more generally, one of radio nodes 118 or switch 128 in FIG. 1). During operation, the access point may receive information (operation 210) that indicates an electronic device is operating in (such as the 2.4 GHz and/or the 5 GHz bands of frequencies) or is predicted to operate in the second band of frequencies, and that the electronic device is within wireless-communication range of the access point. This information may include an identifier of the electronic device (such as a MAC address of the electronic device). Then, the access point may selectively provide, addressed to the electronic device, the unsolicited broadcast probe response (operation 212) in the second band of frequencies based at least in part on the information.

In some embodiments, the access point optionally performs one or more additional operations (operation 214). Notably, the access point may host multiple WLANs. For example, the access point may host a first virtual access point that provides a first WLAN that operates in the first band of frequencies and a second virtual access point that provides a second WLAN that operates in the second band of frequencies. Moreover, the information may be received by the second virtual access point from the first virtual access point.

Alternatively, the access point may receive the information from a second electronic device, such as another access point or a controller.

Furthermore, the information may indicate or specify that the electronic device is capable of operating in the second band of frequencies.

In some embodiments, the first virtual access point may: detect that the electronic device is operating in the first band of frequencies (e.g., the first virtual access point may receive a probe request associated with the electronic device); provide second information about the second virtual access point (e.g., a reduced neighbor report), such as in a beacon or a probe response addressed to the electronic device; and provide the information to the second virtual access point. Moreover, the first virtual access point may determine whether the electronic device is capable of operating in the second band of frequencies (e.g., based on an information element in the probe request that indicates that the electronic device is high-efficiency capable). Furthermore, the first virtual access point may optionally determine whether the electronic device is already known to the first virtual access point (e.g., by comparing the MAC address of the electronic device with stored MAC addresses in a look-up table). When the electronic device is already known to the first virtual access point, the first virtual access point may optionally not provide the information to the second virtual access point.

However, in other embodiments, when an electronic device is scanning in the second band of frequencies, the access point may selectively provide the unsolicited broadcast probe response at a certain time and for a certain duration (such as immediately or within 0.5 s and for a duration of 5-10 s). The electronic device may not need to be new or not previously known to the access point. Moreover, the electronic device may not be associated with the access point in the second band of frequencies.

Note that the unsolicited broadcast probe response may be provided during a time interval (such as the TBTT) and for a time duration. For example, the unsolicited broadcast probe response may be provided every 20 TUs and/or the time duration may be between 5 and 10 s. Moreover, the unsolicited broadcast probe response may be provided starting at a predefined time (such as immediately or within 0.5 s).

In some embodiments, the access point may discontinue providing the unsolicited broadcast probe response in the second band of frequencies: when the electronic device is not operating in the first band of frequencies or is not predicted to operate in the second band of frequencies; when the electronic device is not within wireless-communication range of the access point; or when the time duration has expired.

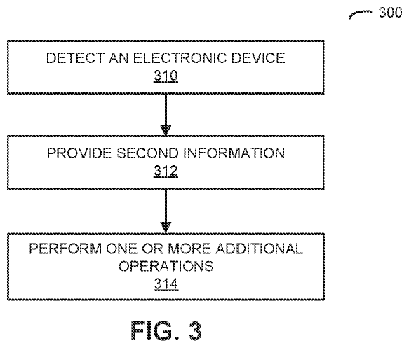

FIG. 3 presents a flow diagram illustrating an example of a method 300 for providing information about an electronic device operating in a first band of frequencies or predicted to operate in a second band of frequencies, which may be performed by a computer (such as computer 112 or one of access points 116, and more generally, one of radio nodes 118 or switch 128 in FIG. 1). During operation, the computer may detect an electronic device (operation 310) that is operating in the first band of frequencies, such as the 2.4 GHz and/or the 5 GHz bands of frequencies. For example, the computer may receive a probe request associated with the electronic device in the first band of frequencies. Alternatively, the computer may receive information about a probe request associated with the electronic device in the first band of frequencies, such as from an access point.

Moreover, the computer may provide information about a second access point that operates in a second band of frequencies (such as the 6 GHz band of frequencies), such as in a beacon or a probe response addressed to the electronic device. In this way, the electronic device may have the information needed to scan for the second access point in the second band of frequencies. For example, the information may be included in a reduced neighbor report. This reduced neighbor report may include: a service set identifier (SSID) of a WLAN hosted by the second access point that operates in the second band of frequencies, a basic service set identifier (BSSID) of the WLAN, and one or more channel numbers of one or more channels in the second band of frequencies used by the WLAN. Note that the reduced neighbor report may include a bit that indicates whether the second access point is capable of providing the unsolicited broadcast probe response in the second band of frequencies.

Then, the computer may provide second information (operation 312) addressed to the second access point. This second information may indicate: that an electronic device is operating in the first band of frequencies or is predicted to operate in the second band of frequencies, and that the electronic device is within wireless-communication range of the second access point. Note that the second information may include an identifier of the electronic device.

In some embodiments, the computer optionally performs one or more additional operations (operation 314). For example, the computer may determine whether the electronic device is capable of operating in the second band of frequencies. This determination may be based on an information element in the probe request that indicates that the electronic device is high-efficiency capable. Moreover, the computer may optionally determine whether the electronic device is already known to the second access point, such as by comparing the MAC address of the electronic device with stored MAC addresses in a look-up table. When the electronic device is already known to the second access point, the computer may optionally not provide the information to the second access point.

In some embodiments of method 200 (FIG. 2) and/or 300, there may be additional or fewer operations. Furthermore, the order of the operations may be changed, and/or two or more operations may be combined into a single operation.

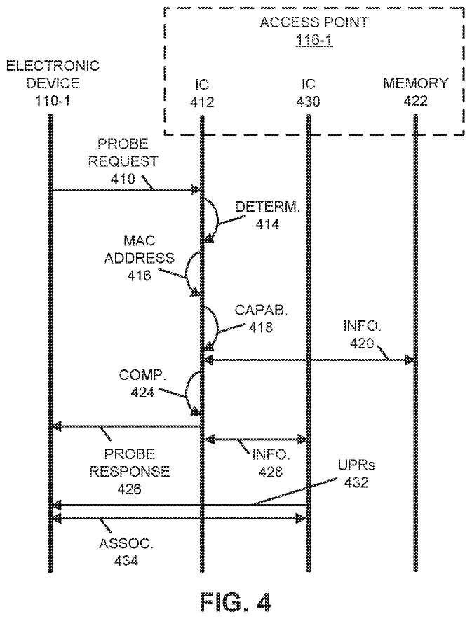

Embodiments of the communication techniques are further illustrated in FIG. 4, which presents a drawing illustrating an example of communication among electronic device 110-1 and access point 116-1. In FIG. 4, an interface circuit in electronic device 110-1 may provide a probe request 410 in a channel in a first band of frequencies (such as the 2.4 GHz and/or the 5 GHz bands of frequencies) to access point 116-1. Then, an interface circuit (IC) 412 in access point 116-1 associated with a first virtual access point that provides a first WLAN that operates in the first band of frequencies may receive probe request 410.

Based at least in part on probe request 410, interface circuit 412 may determine 414 that electronic device 110-1 is operating in the first band of frequencies. Moreover, interface circuit 412 may extract a MAC address 416 of electronic device 110-1 and/or a capability 418 of electronic device 110-1 from probe request 410. Next, interface circuit 412 may optionally compare 424 MAC address 416 to stored MAC addresses of electronic devices that are already known by access point 116-1. For example, interface circuit 412 may access information 420 (such as the MAC addresses) in memory 422 in access point 116-1.

When electronic device 110-1 is optionally not previously known to access point 116-1 (e.g., when electronic device 110-1 is new) and/or capability 418 indicates that that electronic device is capable of operating in the second band of frequencies (such as the 6 GHz band of frequencies), interface circuit 412 may optionally provide a probe response 426 with a reduced neighbor report to electronic device 110-1. This reduced neighbor report may include information that specifies a second WLAN that operates in the second band of frequencies. The probe response 426 may be received by electronic device 110-1. Moreover, interface circuit 412 may provide information 428 to interface circuit 430 in access point 116-1, which may be associated with a second virtual access point that provides the second WLAN that operates in the second band of frequencies. Note that information 428 may, directly or indirectly, indicate: that electronic device 110-1 is operating in the first band of frequencies or is predicted to operate in the second band of frequencies, and that electronic device 110-1 is within wireless-communication range of access point 116-1. Information 428 may include an identifier of electronic device 110-1 (such as a MAC address of electronic device 110-1).

Furthermore, interface circuit 430 may selectively provide, addressed to electronic device 110-1 (e.g., using the MAC address of electronic device 110-1), an unsolicited broadcast probe response (UPRs) 432 in the second band of frequencies based at least in part on information 428. Note that the unsolicited broadcast probe response 432 may be provided during a time interval (such as the TBTT) and for a time duration. For example, the unsolicited broadcast probe response 432 may be provided every 20 TUs and/or the time duration may be between 5 and 10 s. Moreover, the unsolicited broadcast probe response may be provided starting at a predefined time (such as immediately or within 0.5 s).

Based at least in part on probe response 426, the interface circuit in electronic device 110-1 may perform a scan in the second band of frequencies, and may receive one of the unsolicited broadcast probe response 432. Then, the interface circuit in electronic device 110-1 may associate 434 with the interface circuit 430 based at least in part on information included in the received unsolicited broadcast probe response.

In some embodiments, interface circuit 430 may discontinue providing the unsolicited broadcast probe response 432 in the second band of frequencies: when electronic device 110-1 is not operating in the first band of frequencies or is not predicted to operate in the second band of frequencies; when electronic device 110-1 is not within wireless-communication range of the access point; or when the time duration has expired.

While FIG. 4 illustrates communication between components using unidirectional or bidirectional communication with lines having single arrows or double arrows, in general the communication in a given operation in this figure may involve unidirectional or bidirectional communication. Moreover, while FIG. 4 illustrates operations being performed sequentially or at different times, in other embodiments at least some of these operations may, at least in part, be performed concurrently or in parallel.

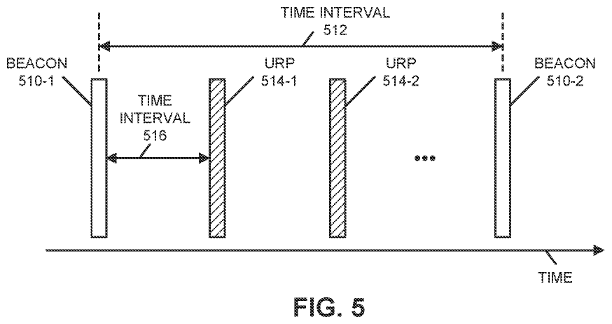

FIG. 5 presents a drawing illustrating an example of messages in a band of frequencies (such as the 6 GHz band of frequencies). Notably, for a given channel in the band of frequencies, an access point may provide beacons 510 once per time interval 512 (such as the TBTT). Moreover, in response to information about an electronic device that is operating in the 2.4 GHz and/or the 5 GHz bands of frequencies or predicted to operate in another band of frequencies (such as the 6 GHz band of frequencies), and that is within wireless-communication range of the access, the access point may selectively provide an unsolicited broadcast probe response 514 in the given channel in the band of frequencies once per time interval 516 (such as every 20 TUs) within time interval 512. These unsolicited broadcast probe responses may be provided for a time duration, such as between 5 and 10 s. Note that the unsolicited broadcast probe response may be provided starting at a predefined time (such as immediately or within 0.5 s).

An access point that operates in the 6 GHz band of frequencies may provide beacons every TBTT and may optionally provide an unsolicited broadcast probe response every 20 TUs. As discussed previously, this may be very time effective for a scanning electronic device (such as a station) to discover a channel in the 6 GHz band of frequencies on which the access point operates. However, sending an unsolicited broadcast probe response every 20 TUs at the basic rate set will consume medium time and will impact the overall throughput. Stated differently, when there are no electronic devices scanning in the 6 GHz band of frequencies, there is no advantage to transmitting the unsolicited broadcast probe response.

The disclosed communication techniques address these problems by indirectly detecting or predicting when an electronic device will be scanning for a channel in the 6 GHz band of frequencies, thereby reducing the overhead and improving the throughput. Notably, when an electronic device performs an active scan (e.g., by providing a probe request) in the 2.4 GHz and/or the 5 GHz bands of frequencies, a first virtual access point that provides a first WLAN in the 2.4 GHz and/or the 5 GHz bands of frequencies (which is cohosted by, collocated by or affiliated with an access point with a second virtual access point that provides a second WLAN in the 6 GHz band of frequencies, and thus may be included in the same physical device) may detect the electronic device.

When the probe request indicates that the electronic device is capable of operating in the 6 GHz band of frequencies (e.g., it includes a high-efficiency information element), it is likely that this electronic device may scan the 6 GHz band of frequencies in the future. Therefore, the first virtual access point may provide a reduced neighbor report to the electronic device (e.g., in a beacon or a probe response) with information about the second virtual access point. Based at least in part on the reduced neighbor report, the electronic device may perform a scan of the 6 GHz band of frequencies (such as of a channel associated with the second virtual access point).

Moreover, the first virtual access point may provide information about the electronic device to the second virtual access point. Notably, this information may indicate that the electronic device is operating in the 2.4 GHz and/or the 5 GHz bands of frequencies or is predicted to operate in the 6 GHz band of frequencies (e.g., is predicted to perform a scan in the 6 GHz band of frequencies based at least in part on the capabilities of the electronic device, and that the electronic device is within wireless-communication range of the second virtual access point. In some embodiments, the information may include a MAC address of the electronic device.

In response, the second virtual access point may provide an unsolicited broadcast probe response addressed to the electronic device in the channel in the 6 GHz band of frequencies for a time duration. For example, the unsolicited broadcast probe response may be provided every 20 TUs during the TBTT for the next 5 to 10 s.

When the electronic device is not operating in the 2.4 GHz and/or the 5 GHz bands of frequencies or is not predicted to operate in the 6 GHz band of frequencies, is not within wireless-communication range of the access, or after the time duration has expired, the access point may not provide or transmit the unsolicited broadcast probe response.

While the preceding discussion illustrated the access point as cohosting multiple virtual access points, in other embodiments the access point cohost multiple access points. Moreover, when the preceding discussion illustrated the use of an unsolicited broadcast probe response, in other embodiments the access point may selectively provide multiple additional beacons during the time interval (such as the TBTT) for the time duration. For example, the additional beacons may be provided every 20 TUs.

We now describe embodiments of an electronic device, which may perform at least some of the operations in the communication techniques. FIG. 6 presents a block diagram illustrating an example of an electronic device 600 in accordance with some embodiments, such as one of: base station 108, one of electronic devices 110, computer 112, one of access points 116, one of radio nodes 118 or switch 128. This electronic device includes processing subsystem 610, memory subsystem 612, and networking subsystem 614. Processing subsystem 610 includes one or more devices configured to perform computational operations. For example, processing subsystem 610 can include one or more microprocessors, graphics processing units (GPUs), ASICs, microcontrollers, programmable-logic devices, and/or one or more digital signal processors (DSPs).

Memory subsystem 612 includes one or more devices for storing data and/or instructions for processing subsystem 610 and networking subsystem 614. For example, memory subsystem 612 can include DRAM, static random access memory (SRAM), and/or other types of memory. In some embodiments, instructions for processing subsystem 610 in memory subsystem 612 include: one or more program modules or sets of instructions (such as program instructions 622 or operating system 624, such as Linux, UNIX, Windows Server, or another customized and proprietary operating system), which may be executed by processing subsystem 610. Note that the one or more computer programs, program modules or instructions may constitute a computer-program mechanism. Moreover, instructions in the various modules in memory subsystem 612 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 610.

In addition, memory subsystem 612 can include mechanisms for controlling access to the memory. In some embodiments, memory subsystem 612 includes a memory hierarchy that comprises one or more caches coupled to a memory in electronic device 600. In some of these embodiments, one or more of the caches is located in processing subsystem 610.

In some embodiments, memory subsystem 612 is coupled to one or more high-capacity mass-storage devices (not shown). For example, memory subsystem 612 can be coupled to a magnetic or optical drive, a solid-state drive, or another type of mass-storage device. In these embodiments, memory subsystem 612 can be used by electronic device 600 as fast-access storage for often-used data, while the mass-storage device is used to store less frequently used data.

Networking subsystem 614 includes one or more devices configured to couple to and communicate on a wired and/or wireless network (i.e., to perform network operations), including: control logic 616, an interface circuit 618 and one or more antennas 620 (or antenna elements). (While FIG. 6 includes one or more antennas 620, in some embodiments electronic device 600 includes one or more nodes, such as antenna nodes 608, e.g., a metal pad or a connector, which can be coupled to the one or more antennas 620, or nodes 606, which can be coupled to a wired or optical connection or link. Thus, electronic device 600 may or may not include the one or more antennas 620. Note that the one or more nodes 606 and/or antenna nodes 608 may constitute input(s) to and/or output(s) from electronic device 600.) For example, networking subsystem 614 can include a Bluetooth™ networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, and/or another networking system.

Note that a transmit or receive antenna pattern (or antenna radiation pattern) of electronic device 600 may be adapted or changed using pattern shapers (such as directors or reflectors) and/or one or more antennas 620 (or antenna elements), which can be independently and selectively electrically coupled to ground to steer the transmit antenna pattern in different directions. Thus, if one or more antennas 620 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 600 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 614 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 600 may use the mechanisms in networking subsystem 614 for performing simple wireless communication between the electronic devices, e.g., transmitting advertising or beacon frames and/or scanning for advertising frames transmitted by other electronic devices as described previously.

Within electronic device 600, processing subsystem 610, memory subsystem 612, and networking subsystem 614 are coupled together using bus 628. Bus 628 may include an electrical, optical, and/or electro-optical connection that the subsystems can use to communicate commands and data among one another. Although only one bus 628 is shown for clarity, different embodiments can include a different number or configuration of electrical, optical, and/or electro-optical connections among the subsystems.

In some embodiments, electronic device 600 includes a display subsystem 626 for displaying information on a display, which may include a display driver and the display, such as a liquid-crystal display, a multi-touch touchscreen, etc.

Moreover, electronic device 600 may include a user-interface subsystem 630, such as: a mouse, a keyboard, a trackpad, a stylus, a voice-recognition interface, and/or another human-machine interface. In some embodiments, user-interface subsystem 630 may include or may interact with a touch-sensitive display in display subsystem 626.

Electronic device 600 can be (or can be included in) any electronic device with at least one network interface. For example, electronic device 600 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 600, in alternative embodiments, different components and/or subsystems may be present in electronic device 600. For example, electronic device 600 may include one or more additional processing subsystems, memory subsystems, networking subsystems, and/or display subsystems. Additionally, one or more of the subsystems may not be present in electronic device 600. Moreover, in some embodiments, electronic device 600 may include one or more additional subsystems that are not shown in FIG. 6. Also, although separate subsystems are shown in FIG. 6, in some embodiments some or all of a given subsystem or component can be integrated into one or more of the other subsystems or component(s) in electronic device 600. For example, in some embodiments instructions 622 is included in operating system 624 and/or control logic 616 is included in interface circuit 618.

Moreover, the circuits and components in electronic device 600 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 614 and/or of electronic device 600. The integrated circuit may include hardware and/or software mechanisms that are used for transmitting wireless signals from electronic device 600 and receiving signals at electronic device 600 from other electronic devices. Aside from the mechanisms herein described, radios are generally known in the art and hence are not described in detail. In general, networking subsystem 614 and/or the integrated circuit can include any number of radios. Note that the radios in multiple-radio embodiments function in a similar way to the described single-radio embodiments.

In some embodiments, networking subsystem 614 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi, LTE and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 622, operating system 624 (such as a driver for interface circuit 618) or in firmware in interface circuit 618. Alternatively or additionally, at least some of the operations in the communication techniques may be implemented in a physical layer, such as hardware in interface circuit 618.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An access point, comprising:
an interface circuit configured to communicate with an electronic device, wherein the access point is configured to perform operations comprising:
receiving information that indicates the electronic device is operating in a first band of frequencies or is predicted to operate in a second band of frequencies, and that the electronic device is within wireless-communication range of the access point, wherein the information comprises an identifier of the electronic device; and
selectively providing, addressed to the electronic device, an unsolicited broadcast probe response in the second band of frequencies based at least in part on the information.

2. The access point of claim 1, wherein the first band of frequencies comprises at least one of a 2.4 GHz band of frequencies or a 5 GHz band of frequencies, and the second band of frequencies comprises a 6 GHz band of frequencies.

3. The access point of claim 1, wherein the identifier comprises a media access control (MAC) address of the electronic device.

4. The access point of claim 1, wherein the access point hosts a first virtual access point that provides a first WLAN that operates in the first band of frequencies and a second virtual access point that provides a second WLAN that operates in the second band of frequencies; and
wherein the information is received by the second virtual access point from the first virtual access point.

5. The access point of claim 4, wherein the first virtual access point performs one or more of: detecting that the electronic device is operating in the first band of frequencies; determining whether the electronic device is capable of operating in the band of frequencies; and providing second information about the second virtual access point addressed to the electronic device.

6. The access point of claim 1, wherein the access point receives the information from a second electronic device.

7. The access point of claim 6, wherein the second electronic device comprises another access point or a controller of the access point.

8. The access point of claim 1, wherein the information indicates that the electronic device is capable of operating in the second band of frequencies.

9. The access point of claim 1, wherein the unsolicited broadcast probe response is provided during a time interval and for a time duration.

10. The access point of claim 9, wherein the time interval comprises a target beacon transmit time (TBTT).

11. The access point of claim 9, wherein the unsolicited broadcast probe response is provided every 20 transmitting units (TUs).

12. The access point of claim 9, wherein the time duration is between 5 and 10 s.

13. The access point of claim 9, wherein the access point is configured to discontinue providing the unsolicited broadcast probe response in the second band of frequencies: when the electronic device is not operating in the first band of frequencies or is not predicted to operate in the second band of frequencies; when the electronic device is not within wireless-communication range of the access point; or after the time duration has expired.

14. A non-transitory computer-readable storage medium for use in conjunction with an access point, the computer-readable storage medium storing program instructions that, when executed by the access point, cause the access point to perform operations comprising:
receiving information that indicates an electronic device is operating is operating in a first band of frequencies or is predicted to operate in a second band of frequencies, and that the electronic device is within wireless-communication range of the access point, wherein the information comprises an identifier of the electronic device; and
selectively providing, addressed to the electronic device, an unsolicited broadcast probe response in the second band of frequencies based at least in part on the information.

15. The non-transitory computer-readable storage medium of claim 14, wherein the first band of frequencies comprises at least one of a 2.4 GHz band of frequencies or a 5 GHz band of frequencies, and the second band of frequencies comprises a 6 GHz band of frequencies.

16. The non-transitory computer-readable storage medium of claim 14, wherein the access point hosts a first virtual access point that provides a first WLAN that operates in the first band of frequencies and a second virtual access point that provides a second WLAN that operates in the second band of frequencies; and
wherein the information is received by the second virtual access point from the first virtual access point.

17. The non-transitory computer-readable storage medium of claim 14, wherein the access point receives the information from a second electronic device.

18. The non-transitory computer-readable storage medium of claim 14, wherein the information indicates that the electronic device is capable of operating in the second band of frequencies.

19. The non-transitory computer-readable storage medium of claim 14, wherein the unsolicited broadcast probe response is provided during a time interval and for a time duration; and
wherein the operations comprise discontinuing providing the unsolicited broadcast probe response in the second band of frequencies: when the electronic device is not operating in the first band of frequencies or is not predicted to operate in the second band of frequencies, when the electronic device is not within wireless-communication range of the access point; or when the time duration has expired.

20. A method for providing an unsolicited broadcast probe response in a second band of frequencies, comprising:
by an access point:
receiving information that indicates an electronic device is operating is operating in a first band of frequencies or is predicted to operate in the second band of frequencies, and that the electronic device is within wireless-communication range of the access point, wherein the information comprises an identifier of the electronic device; and
selectively providing, addressed to the electronic device, the unsolicited broadcast probe response in the second band of frequencies based at least in part on the information.
